(19) United States
(12) Patent Application Publication
(10) Pub. No.: US 2015/0365223 A1
(43) Pub. Date: Dec. 17, 2015

(54) TRANSMISSION DEVICE AND DELAY MEASUREMENT METHOD

(71) Applicant: FUJITSU LIMITED, Kawasaki-shi (JP)

(72) Inventors: Toshihiro SUZUKI, Kawasaki (JP); Hideaki SUGIYA, Fujisawa (JP); Tomoko MURAKAMI, Kawasaki (JP)

(73) Assignee: FUJITSU LIMITED, Kawasaki (JP)

(21) Appl. No.: 14/686,006

(22) Filed: Apr. 14, 2015

(30) Foreign Application Priority Data
Jun. 12, 2014 (JP) 2014-121798

(51) Int. Cl. H04L 7/00; H04Q 11/00; H04L 1/00; H04B 10/079

(52) U.S. Cl. CPC H04L 7/0075; H04B 10/0795; H04Q 11/0066; H04L 1/0047; H04L 7/0041; H04Q 2011/0083; H04Q 2011/0045

(57) ABSTRACT

A transmission device includes: a transmitter configured to transmit frames including a bit string having a predetermined pattern to an opposite device to the transmission device; a measurement unit configured to measure an elapsed time from a first time at the transmission of the frames including the bit string having the predetermined pattern to the opposite device to a second time at a reception of the frames including the bit string having the predetermined pattern from the opposite device; and a determination unit configured to determine a transmission delay time between the transmission device and the opposite device, based on the measurement result of the measurement unit.

### CROSS-REFERENCE TO RELATED APPLICATION

This application is based upon and claims the benefit of priority of the prior Japanese Patent Application No. 2014-121798, filed on Jun. 12, 2014, the entire contents of which are incorporated herein by reference.

### FIELD

The embodiments discussed herein are related to a transmission device and a delay measurement method.

### BACKGROUND

In a conventional optical transmission system for transmitting data in units of frames, measurement (delay measurement: DM) of a transmission delay between nodes is performed to check the reliability of data transmission. Such DM is preferably performed during the operation of the optical transmission system.

As to the DM, ITU-T G.709 standard includes description about delay measurement. According to this standard, the DM is performed using 1 bit in an optical transport network (OTC) frame. To be more specific, in normal operation, bits for delay measurement are looped back by an OTN terminal station. Then, upon start of delay measurement, the OTN terminal station on the measurement side inverts the received bits for delay measurement and transmits the inverted bits. Thereafter, when the OTN terminal station on the measurement side receives three successive frames containing bit-inverted data looped back by an OTN terminal station on the opposite side, the OTN terminal station determines that the transmission frames have come back after going back and forth on a transmission line. Based on the number of the frames between the transmission and the reception in this event, the OTN terminal station calculates a delay time.

Related techniques are disclosed in, for example, Japanese Laid-open Patent Publication No. 2013-153367.

### SUMMARY

According to an aspect of the invention, a transmission device includes: a transmitter configured to transmit frames including a bit string having a predetermined pattern to an opposite device to the transmission device; a measurement unit configured to measure an elapsed time from a first time at the transmission of the frames including the bit string having the predetermined pattern to the opposite device to a second time at a reception of the frames including the bit string having the predetermined pattern from the opposite device; and a determination unit configured to determine a transmission delay time between the transmission device and the opposite device, based on the measurement result of the measurement unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a configuration of a transmission device according to a first embodiment;

FIG. 2 is an explanatory diagram illustrating a configuration of an OTN frame;

FIG. 3 is an explanatory diagram illustrating a configuration of DM transmission data;

FIG. 4 is a flowchart illustrating an example of operations of the transmission device according to the first embodiment;

FIG. 5 is an explanatory diagram illustrating an operation example of the transmission device according to the first embodiment;

FIGS. 6A and 6B are explanatory diagrams illustrating an operation example of the transmission device according to the first embodiment;

FIGS. 7A and 7B are explanatory diagrams illustrating an operation example of the transmission device according to the first embodiment;

FIG. 8 is a flowchart illustrating an example of operations of a transmission device according to a second embodiment;

FIGS. 9A and 9B are explanatory diagrams illustrating an operation example of the transmission device according to the second embodiment;

FIGS. 10A and 10B are explanatory diagrams illustrating an operation example of the transmission device according to the second embodiment; and

FIGS. 11A and 11B are explanatory diagrams illustrating an operation example of the transmission device according to the second embodiment.

### DESCRIPTION OF EMBODIMENTS

In the conventional technology, a delay time is erroneously detected in DM. For example, when signal disturbance occurs, bits for delay measurement are inverted reversely, leading to false detection of a delay time. Moreover, since respective OTN terminal stations operate independently, when an opposite station opposite to the own station also starts DM and causes competition, a delay time is calculated using a frame transmitted by the opposite station, which may result in false detection of the delay time.

Hereinafter, with reference to the drawings, description is given of a transmission device and a delay measurement method, which are capable of suppressing false detection in measurement of a transmission delay between nodes. In the following embodiments, constituent components having the same functions are denoted by the same reference numerals, and repetitive description thereof is omitted. Note that the transmission device and delay measurement method described in the following embodiments are for illustrative purposes only and are not intended to limit the embodiments. Moreover, the following embodiments may be combined, as appropriate, in any manner that is not contradictory.

### First Embodiment

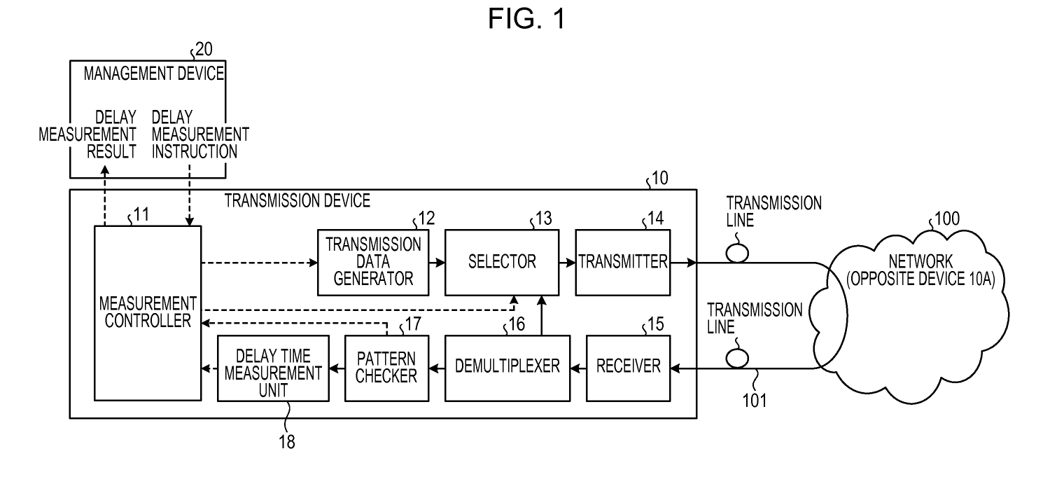

FIG. 1 is a block diagram illustrating a configuration of a transmission device 10 according to a first embodiment. As illustrated in FIG. 1, the transmission device 10 is a node connected to a network 100 through a transmission line 101 such as optical fiber. The network 100 includes an opposite device 10A that is a node opposite to the transmission device 10 through the transmission line 101. The transmission device 10 transmits frames each having a predetermined structure to the opposite device 10A, and receives frames from the opposite device 10A.

The transmission device 10 transmits and receives frames according to instructions of a management device 20 such as a Micro Controller Unit (MCU). For example, upon receipt of a delay measurement instruction for measurement (DM) of a transmission delay between the transmission device 10 and the opposite device 10A from the management device 20, the transmission device 10 performs DM by transmitting and receiving frames to and from the opposite device 10A. Next, the transmission device 10 sends the measured delay time, as a delay measurement result, back to the management device 20. Here, the delay time in the DM corresponds to a propagation time of a signal (optical signal) on the transmission line 101. However, the delay time may include processing time and the like within the transmission device 10 and the opposite device 10A.

For example, in the DM, the transmission device 10 transmits a frame to the opposite device 10A. The opposite device 10A sends back (in other words, loops back) predetermined information in the frame received from the transmission device 10 to the transmission device 10. Then, the transmission device 10 measures a delay time based on an amount of time between the time when a frame is transmitted to the opposite device 10A and the time when the frame comes back from the opposite device 10A.

Note that a transmission system including the transmission device 10 and the opposite device 10A according to this embodiment is not particularly limited, but is configured to transmit frames according to the OTN standard. The OTN standard is described in ITU-T G.709/Y.1331. Note that, in the following description, the frames according to the OTN standard may be called “OTN frames” or simply “frames”.

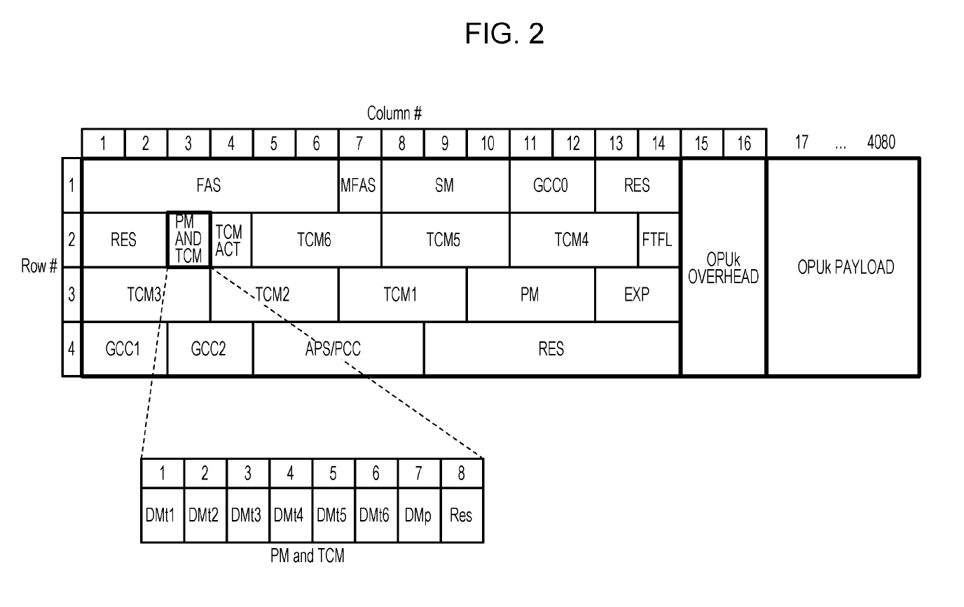

FIG. 2 is an explanatory diagram illustrating a configuration of the OTN frame. As illustrated in FIG. 2, the OTN frame includes an overhead and an OPUk payload. Client data is stored in the OPUk payload. Although not illustrated, the OTN frame may further include an error-correcting code after the OPUk payload.

The overhead includes a frame alignment overhead, an OTUk overhead, an ODUk overhead, and an OPUk overhead. Here, the OPUk overhead is attached to the OPUk payload to form an OPUk frame. Also, the ODUk overhead is attached to the OPUk frame to form an ODUk frame. The ODUk overhead is located in Rows #2 to #4 and Columns #1 to #14. Furthermore, the OTUk overhead and the frame alignment overhead are attached to the ODUk frame. Note that the above abbreviations stand for the following: OTU: Optical channel Transport Unit; ODU: Optical channel Data Unit; and OPU: Optical channel Payload Unit.

In the OTN, the DM between the transmission devices 10 may be performed using PM&TCM in the ODUk overhead. PM&TCM is located in Row #2 and Column #3 in the OTN frame. The first to sixth bits of PM&TCM are used as DMt1 to DMt6, respectively. The seventh bit of PM&TCM is used as DMp. The eighth bit of PM&TCM is not in use.

Note that main abbreviations described in FIG. 2 stand for the following: PM: Path Monitoring; TCM: Tandem Connection Monitoring; RES: Reserved for future international standardization; ACT: Activation/deactivation control channel; FTFL: Fault Type & Fault Location coordination channel; EXP: Experimental; GCC: General Communication Channel; APS: Automatic Protection Switching coordination channel; PCC: Protection Communication Control channel; and DM: Delay Measurement.

Referring back to FIG. 1, the transmission device 10 includes a measurement controller 11, a transmission data generator 12, a selector 13, a transmitter 14, a receiver 15, a demultiplexer 16, a pattern checker 17, and a delay time measurement unit 18.

The measurement controller 11 controls operations of the transmission device 10. To be more specific, upon receipt of a delay measurement instruction from the management device 20, the measurement controller 11 controls DM by transmitting and receiving frames to and from the opposite device 10A. The measurement controller 11 includes a Central Processing Unit (CPU), a Read Only Memory (ROM), a Random Access Memory (RAM), and the like. The measurement controller 11 controls the DM by the CPU developing programs stored in the ROM into the RAM and sequentially executing the programs.

The transmission data generator 12 generates the OTN frame illustrated in FIG. 2, which is transmission data to be transmitted to the network 100, under the control of the measurement controller 11. In this event, the transmission data generator 12 sets (adds) a predetermined bit in the OTN frame according to an instruction of the measurement controller 11. For example, in execution of the DM, a DM bit is set. The DM bit is one bit in one byte in Row #2 and Column #3, and corresponds to the DMt1 to DMt6 bits or the DMp bit in the ODUk overhead.

Here, in execution of the DM under the control of the measurement controller 11, the transmission data generator 12 sets the DM bit of each frame so that, when DM bits are transmitted between frames, a bit string of the transmitted DM bits has a predetermined pattern. Thus, the transmission device 10 transmits DM transmission data including bit strings of the DM bits extending to frames by transmitting the DM bits extending to the frames.

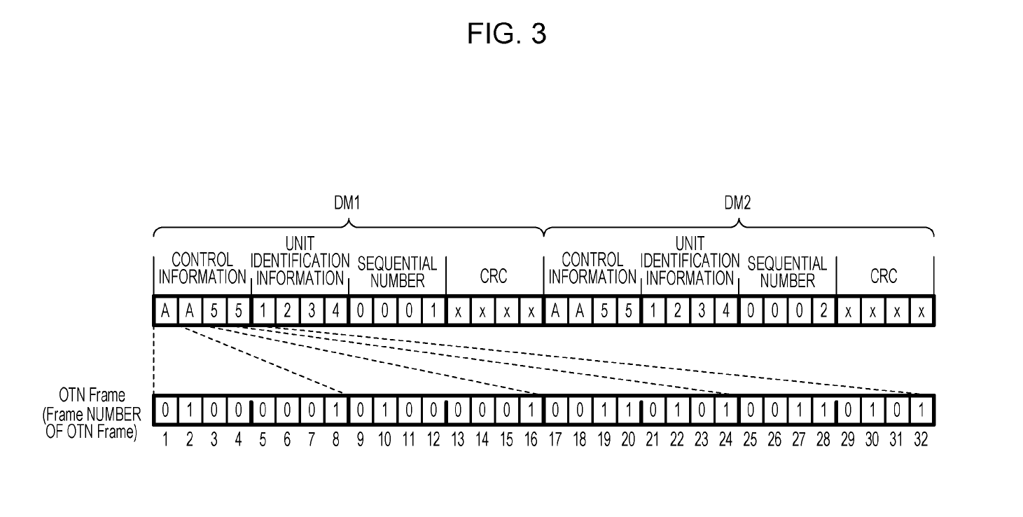

FIG. 3 is an explanatory diagram illustrating a configuration of the DM transmission data. As illustrated in FIG. 3, the DM transmission data (hereinafter called the DM data) DM1 and DM2 each have a configuration in which DM bit values (“1” or “0”) of OTN frames are arranged. The DM data (DM1 and DM2) includes control information, unit identification information, order number, and Cyclic Redundancy Check (CRC).

The control information is information indicating a control state of the own device, and may be information indicating a control state about the DM, for example. Here, the control state about the DM may include start of DM, end of DM, Ack transmission about DM, during DM, requesting loop-back to execute DM, and the like. Moreover, the control information may be a code (for example, “AA55” or the like) or the like corresponding to the control state described above.

Hereinafter, a code pattern indicating start of the DM in the control information is referred to as the DM start pattern. Likewise, a code pattern indicating termination of the DM is referred to as the DM termination pattern. Also, a code pattern indicating Ack transmission about the DM is referred to as the Ack pattern. Moreover, a code pattern indicating that the DM is underway is referred to as the DM measurement pattern. Furthermore, a code pattern indicating a request for loopback to execute the DM is referred to as the loopback request pattern.

The unit identification information may be a device-specific pattern or the like to identify the transmission device 10 that is the source. For example, the unit identification information may be a combination of a model number and a serial number, indicating a unit type, or the like. Moreover, in Muxponder or the like, the unit identification information may include a Port number. The receiving side may identify the source of a frame by referring to the unit identification information.

The order number is information for specifying the order of transmitting the DM data DM1 and DM2 to be transmitted with the control information, unit identification information, order number, and CRC as one chunk. Note that, as the order number, not only a simple number but also a transmission time or the like may be used as a unique transmission number. The order number is preferably used to measure a correct delay time when the DM data DM1 and DM2 are missing, for example.

The CRC is check data to determine the validity of the DM data DM1 and DM2. The receiving side may determine whether or not the received DM data DM1 and DM2 is accurate and valid, by referring to the CRC. Note that, instead of the CRC for error detection, a cyclic code or the like capable of error detection and error correction may be used.

As a method for transmitting the DM data DM1 and DM2, as in the example illustrated in FIG. 3, 8 frames may represent 1 character, and an ASCII code may be used to transmit an arbitrary character. In this case, the number of frames corresponding to the number of characters to be transmitted×8 frames is used to transmit the DM data DM1 and DM2. For example, the control information such as “AA55” may be transmitted using DM bits for 32 frames from the top.

The selector 13 outputs the OTN frame generated by the transmission data generator 12 to the transmitter 14, under the control of the measurement controller 11. In this event, the selector 13 performs loopback by setting the predetermined information in the frame received from the network 100 in the OTN frame generated by the transmission data generator 12 and then outputting the OTN frame to the transmitter 14. For example, when the transmission device 10 that is the own device is not performing the DM, the selector 13 sets the DM bit value of the frame demultiplexed by the demultiplexer 16 as the DM bit of the transmission frame. In other words, loopback of the DM bit is performed. Through this loopback, for example, the opposite device 10A transmits the frame having the predetermined DM bit set therein, when performing the DM. Then, the opposite device 10A receives the frame looped back from the transmission device 10. Thus, the delay time may be measured.

The transmitter 14 sequentially outputs the OTN frames outputted from the selector 13 to the network 100 at regular intervals. In this event, the transmitter 14 converts the frame into a data string, for example, and transmits an optical signal indicating the data string to the opposite device 10A in the network 100. Note that the transmitter 14 includes an optical modulator and the like.

The receiver 15 receives the frame through the network 100. In this event, the receiver 15 reproduces the data string by demodulating the received optical signal, and reconstructs a frame from the data string. Then, the receiver 15 outputs the frame (received frame) reconstructed from the received optical signal to the demultiplexer 16.

The demultiplexer 16 demultiplexes various information from the received frame outputted by the receiver 15. The demultiplexed various information is outputted to the selector 13 and the pattern checker 17. For example, the demultiplexer 16 demultiplexes the predetermined bit value (for example, the DM bit value) from the received frame, and outputs the value to the selector 13 and the pattern checker 17.

The pattern checker 17 checks the information demultiplexed from the received frame by the demultiplexer 16, and outputs the check result to the measurement controller 11 and the delay time measurement unit 18. To be more specific, the pattern checker 17 checks the DM data including the bit strings of the DM bits demultiplexed extending to more than one received frame. For example, the pattern checker 17 checks a control state of the source based on the control information in the DM data, and checks the source based on the unit identification information. The pattern checker 17 also checks the transmission order of the DM data based on the order number, and checks an error in the DM data based on the CRC.

In the transmission device 10, when the DM is performed, the DM data including the control information, unit identification information, order number, and CRC is transmitted through the bit strings of the DM bits extending to more than one frame. Therefore, the DM data transmitted by the own device may be identified by the pattern checker 17 checking the DM data.

The delay time measurement unit 18 measures a delay time between the transmission of the DM data to the opposite device 10A and the reception of the DM data from the opposite device 10A, based on the check result from the pattern checker 17. For example, the delay time measurement unit 18 measures a delay time between the transmission of a last frame of the DM data and the reception of the last frame. Thus, in the transmission device 10, when the DM is performed, false detection due to signal disturbance on the transmission line 101, DM competition with the opposite device 10A, and the like may be suppressed by identification using the DM data including the bit strings of the DM bits extending to more than one frame.

For example, the delay time measurement unit 18 uses the pattern checker 17 to identify the DM data transmitted by the own device, and measures the delay time between the transmission and reception of the DM data. Thus, the delay time measurement unit 18 may suppress the false detection due to the DM competition with the opposite device 10A. Also, based on DM data determined to be valid since no errors are detected in CRC error check by the pattern checker 17, the delay time measurement unit 18 measures a delay time between the transmission and reception of the DM data. Thus, the delay time measurement unit 18 may also suppress the false detection due to the signal disturbance on the transmission line 101.

The delay time measured by the delay time measurement unit 18 is outputted to the measurement controller 11. The measurement controller 11 determines a measurement result (delay measurement result) of the DM based on the delay time measured by the delay time measurement unit 18, and notifies the management device 20 of the measurement result.

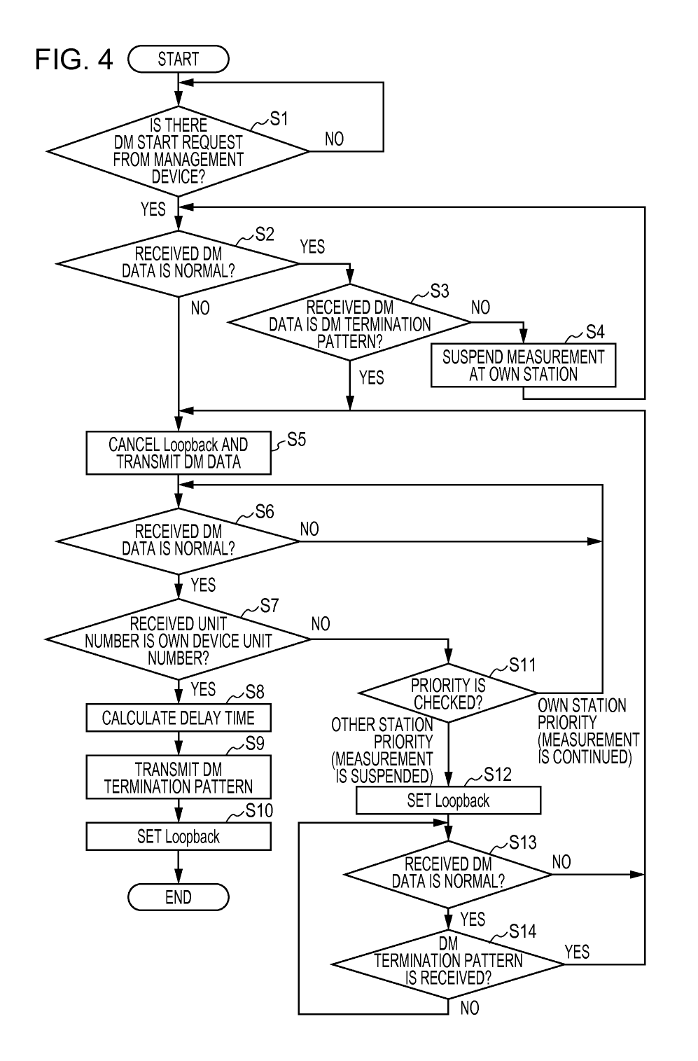

FIG. 4 is a flowchart illustrating an example of operations of the transmission devices (10 and 10A) according to the first embodiment. As illustrated in FIG. 4, once processing is started, the measurement controller 11 determines whether or not there is a DM start request that is a delay measurement instruction from the management device 20 (S1). When there is no DM start request (S1: NO), the measurement controller 11 puts the processing on standby. Since no DM is performed during the standby of the processing, a DM bit value of a frame demultiplexed by the demultiplexer 16 is set as a DM bit of a transmission frame and is looped back.

On the other hand, when there is the DM start request (S1: YES), the measurement controller 11 determines whether or not the DM data received by the own device is normal, based on the output from the pattern checker 17 (S2). This determination is to determine whether or not the DM data transmitted by the own device or the opposite device 10A has been successfully received, the DM data including control information, unit identification information, order number, CRC, and the like. Therefore, when the own device or the opposite device 10A has transmitted no DM data, resulting in an indefinite value, the result of the determination is negative (NO).

When the DM data received by the own device is normal (S2: YES), the measurement controller 11 determines whether or not the received DM data includes a DM termination pattern (S3). When the DM data includes the DM termination pattern (S3: YES), the DM is terminated, and thus the measurement controller 11 advances the processing to S5.

On the other hand, when the DM data does not include the DM termination pattern (S3: NO), the measurement controller 11 suspends the DM at the own device (own station) (S4), and returns the processing to S2. When the DM data received by the own device is normal but the DM data does not include the DM termination pattern, it means that the opposite device 10A is preparing for DM or performing the DM. In such a case, the measurement controller 11 suspends the DM at the own device (own station) through the processing of S4.

On the other hand, when the DM data received by the own station is not normal (S2: NO) and when the DM data includes the DM termination pattern (S3: YES), the measurement controller 11 cancels the setting of the loopback at the selector 13, and starts transmission of the DM data for the DM (S5).

Next, as in the case of S2, the measurement controller 11 determines whether or not the DM data received by the own station is normal (S6). When the DM data received by the own station is not normal (S6: NO), the measurement controller 11 puts the processing on standby since the DM data started in S5 is not back yet.

On the other hand, when the DM data received by the own station is normal (S6: YES), the measurement controller 11 determines whether or not the received DM data is the one transmitted from the own station (S7). To be more specific, the measurement controller 11 determines whether or not the unit number indicated by the unit identification information in the received DM data corresponds to the unit number of the own device.

When the received DM data is the one transmitted from the own station (S7: YES), the measurement controller 11 calculates an actual delay time based on the delay time measured by the delay time measurement unit 18, since the DM data transmitted by the own station is back (S8). For example, the measurement controller 11 calculates the actual delay time by taking into consideration time that takes, and the like, besides the delay time measured by the delay time measurement unit 18, and then outputs the calculated time as the measurement result of the DM to the management device 20.

Next, the measurement controller 11 transmits the DM data including the DM termination pattern (S9) and sets loopback at the selector 13 (S10).

On the other hand, when the received DM data is not the one transmitted from the own station (S7: NO), since the DM data transmitted by the opposite device 10A (other station) has been received, the measurement controller 11 performs priority check to determine which station, the own station, or other station, has higher priority (S11).

To be more specific, the measurement controller 11 determines the priority by referring to information set beforehand in a memory or the like as a higher-priority station, based on the unit number in the received DM data. For example, if the unit number of the higher-priority station is set beforehand, the measurement controller 11 determines whether or not the unit number in the received DM data corresponds to the one set in the memory. Moreover, if information (own station priority, other station priority, or the like) indicating conditions of the higher-priority station is set, the measurement controller 11 determines whether or not the unit number in the received DM data meets the set conditions.

When the own station has higher priority and the priority is placed on the own station (S11: own station priority), the measurement controller 11 returns the processing to S6, and continues the DM at the own station. Thus, even if DM competition occurs between the own station and other station, the DM at the own station having higher priority may be continued.

On the other hand, when other station has higher priority and the priority is placed on the other station (S11: other station priority), the measurement controller 11 sets the selector 13 to perform loopback of the DM bit since the DM at the own station is suspended (S12). Thus, even if DM competition occurs between the own station and the other station, the DM at the other station having higher priority may be continued.

Next, as in the case of S2, the measurement controller 11 determines whether or not the DM data received by the own station is normal (S13). When the DM data received by the own station is normal (S13: YES), the measurement controller 11 determines whether or not the received DM data includes a DM termination pattern (S14). When the DM data does not include the DM termination pattern (S14: NO), the measurement controller 11 returns the processing to S13, since the DM at the other station is ongoing.

On the other hand, when the DM data received by the own station is not normal (S13: NO) and when the DM data includes the DM termination pattern (S14: YES), the measurement controller 11 advances the processing to S5, since the DM at the other station is terminated. Thus, after the termination of the DM at the other station, DM at the own station is started.

Here, description is given of each case of an operation example of the transmission device 10 according to the first embodiment. First, description is given of a case where DM is performed at the transmission device 10 and no DM is performed at the opposite device 10A.

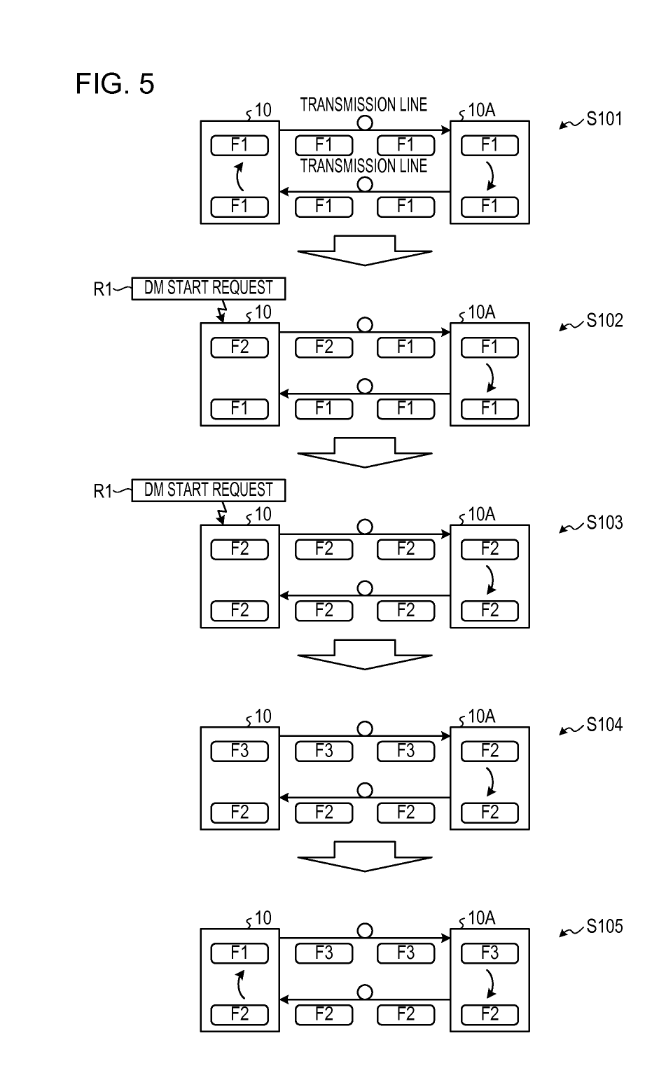

FIG. 5 is an explanatory diagram illustrating an operation example of the transmission devices (10 and 10A) according to the first embodiment. As illustrated in FIG. 5, before the transmission device 10 receives a DM start request R1 (S101), DM bits of frames F1 transmitted and received between the transmission device 10 and the opposite device 10A are loopbacked. Also, each of the frames F1 has an indefinite DM bit value since no DM data settings are configured.

Next, upon receipt of the DM start request R1 from the management device 20, the transmission device 10 sequentially transmits frames F2 having the DM data according to the DM start request R1 to the transmission line 101 (S102). Here, the DM data transmitted through the frames F2 includes control information, unit identification information, order number, and CRC, and the control information is a DM pattern. Also, the transmission device 10 cancels the setting of the loopback of the DM bits.

Next, upon receipt of the frame F2 having the DM data according to the DM start request R1 from the opposite device 10A, the transmission device 10 calculates a delay time between the transmission and reception of the DM data (S103). For example, the delay time may be calculated based on the number of frames between the transmission and reception of the DM data, and the like.

Upon termination of the DM after the calculation of the delay time, the transmission device 10 sequentially transmits frames F3 having the DM data including the DM termination pattern as the control information (S104). Then, as the transmission of the frames F3 of the predetermined number is completed, the transmission device 10 sets loopback of the DM bits at the selector 13 (S105).

In the case illustrated in FIG. 5, the opposite device 10A performs no special processing. Therefore, if the opposite device 10A is configured to operate according to standards to continue the loopback of the DM bits, even when the operations in the flowchart described above are not supported, the transmission device 10 may perform the DM.

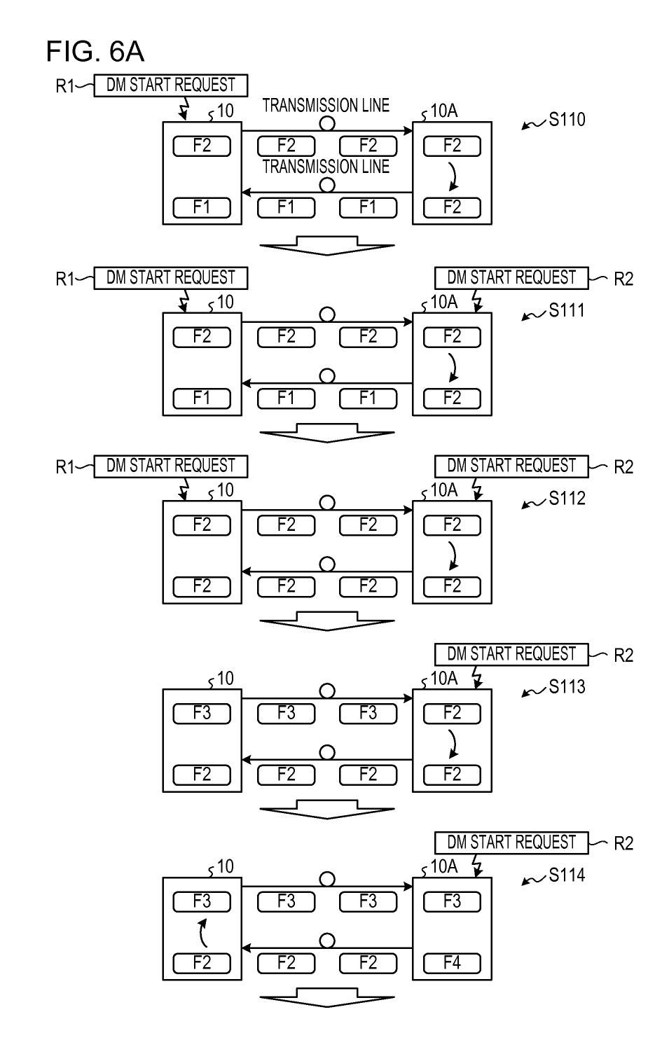

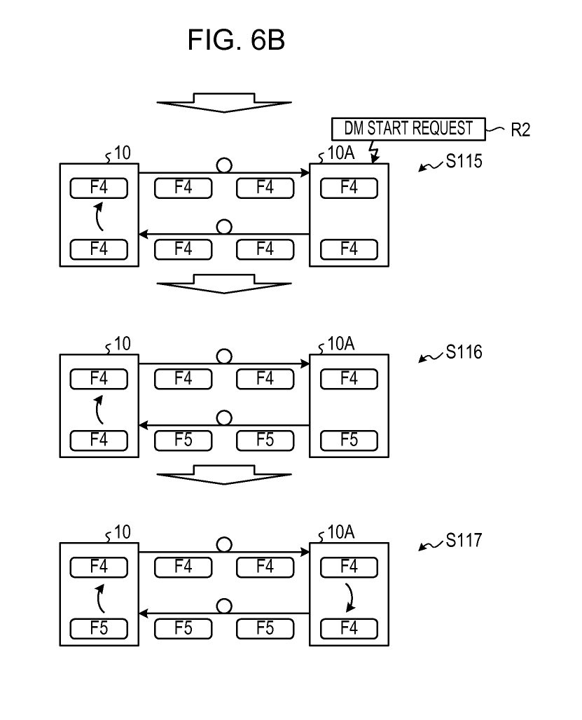

Next, description is given of a case where the opposite device 10A receives a DM start request R2 from the management device 20 during the DM at the transmission device 10. FIGS. 6A and 6B are explanatory diagrams illustrating an operation example of the transmission devices (10 and 10A) according to the first embodiment.

As illustrated in FIGS. 6A and 6B, the transmission device 10 is performing the DM and the opposite device 10A has received the frames F2 having the DM data according to the performing the DM transmitted by the transmission device 10 (S110).

In this event, when the opposite device 10A has received the DM start request R2 from the management device 20 (S111), the opposite device 10A maintains the loopback of the DM bits without starting DM, since the opposite device 10A is still receiving the DM data according the performing the DM from the transmission device 10.

Next, upon receipt of the frames F2 having the DM data according to the performing the DM from the opposite device 10A, the transmission device 10 calculates a delay time between the transmission and reception of the DM data (S112). Then, upon termination of the DM after the calculation of the delay time, the transmission device 10 sequentially transmits frames F3 having the DM data according to the DM termination pattern as the control information (S113).

Thereafter, upon completion of the transmission of the frames F3 of the predetermined number, the transmission device 10 sets loopback of the DM bits at the selector 13. Moreover, upon receipt of the frames F3 having the DM data according to the DM termination pattern, the opposite device 10A cancels the setting of the loopback at the selector 13 and sequentially transmits frames F4 having the DM data according to the DM start request R2 to the transmission line 101 (S114). Here, the DM data transmitted through the frames F4 includes control information, unit identification information, order number, and CRC, and the control information is a DM pattern.

Thereafter, as in the case of the transmission device 10, the opposite device 10A also performs DM processing. To be more specific, upon receipt of the frames F4 having the DM data according to the DM start request R2 from the transmission device 10, the opposite device 10A calculates a delay time between the transmission and reception of the DM data (S115). Then, upon termination of the DM, the opposite device 10A sequentially transmits frames F5 having the DM data according to the DM termination pattern as the control information (S116). Thereafter, as the transmission of the frames F5 having the DM data according to the DM termination pattern is completed, the opposite device 10A sets loopback of the DM bits at the selector 13 (S117).

As described above, even when the opposite device 10A receives the DM start request R2 from the management device 20 during the DM at the transmission device 10, the DM may be put on standby on the opposite device 10A side based on the control information in the DM data from the transmission device 10. Then, the opposite device 10A may start the DM once the DM is terminated at the transmission device 10.

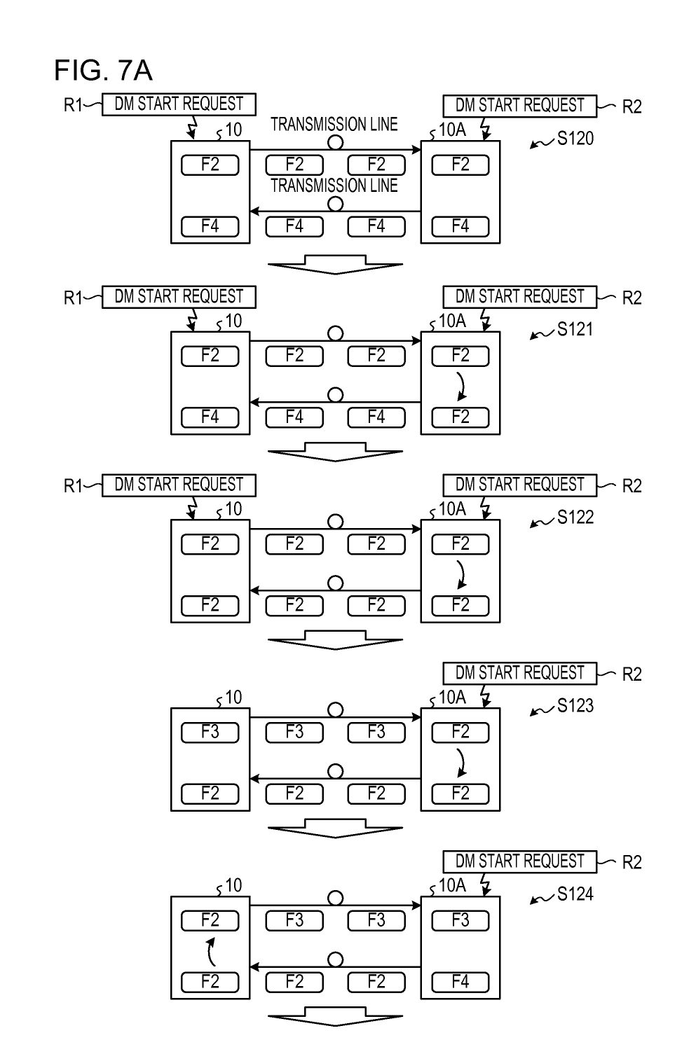

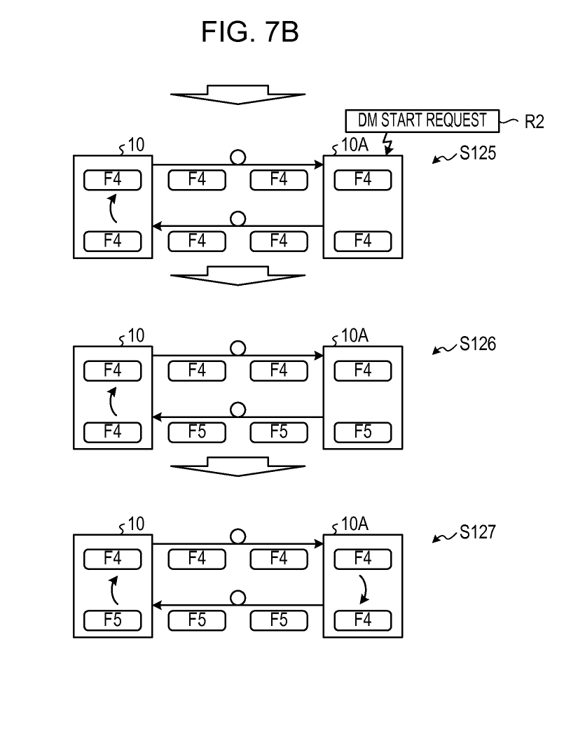

Next, description is given of a case where the transmission device 10 and the opposite device 10A each receive a DM start request R2, and DM is simultaneously started. FIGS. 7A and 7B are explanatory diagrams illustrating an operation example of the transmission devices (10 and 10A) according to the first embodiment.

As illustrated in FIGS. 7A and 7B, the transmission device 10 and the opposite device 10A receive DM start requests R1 and R2 approximately at the same time, and DM is started at the both stations (S120). In this event, sets of loopback of DM bits are cancelled at the both stations since the DM is started. Moreover, the transmission device 10 is set to have higher priority.

After the start of the DM, the transmission device 10 receives frames F4 having DM data according to the DM start request R2 of the opposite device 10A, while the opposite device 10A receives frames F2 having DM data according to the DM start request R1 of the transmission device 10 (S121). Here, the both of the transmission device 10 and the opposite device 10A determine the priority based on the unit number of the received DM data.

In this case, since the transmission device 10 is set to have higher priority, the DM on the transmission device 10 side is continued. Then, on the opposite device 10A side, the DM is suspended and loopback of the DM bit is set.

Next, as in the case of S112 and S113, DM on the transmission device 10 side is performed (S122 and S123). Then, as the DM on the transmission device 10 side is terminated, DM on the opposite device 10A side is performed as in the case of S114 to S117 (S124 to S127).

As described above, even when the DM is started simultaneously at both of the transmission device 10 and the opposite device 10A, the DM may be performed in descending order of priority based on the unit identification information in the DM data from the transmission device 10, without the both devices competing against each other.

### Second Embodiment

In the above first embodiment, the description is given of the operation where the transmission device 10 and the opposite device 10A cooperatively take turn performing the DM when competition with the opposite device 10A occurs during the DM. However, the transmission device 10 and the opposite device 10A may cooperate before the DM. In a second embodiment, description is given of a case where DM is executed after cooperation between the transmission device 10 and the opposite device 10A upon start of the DM.

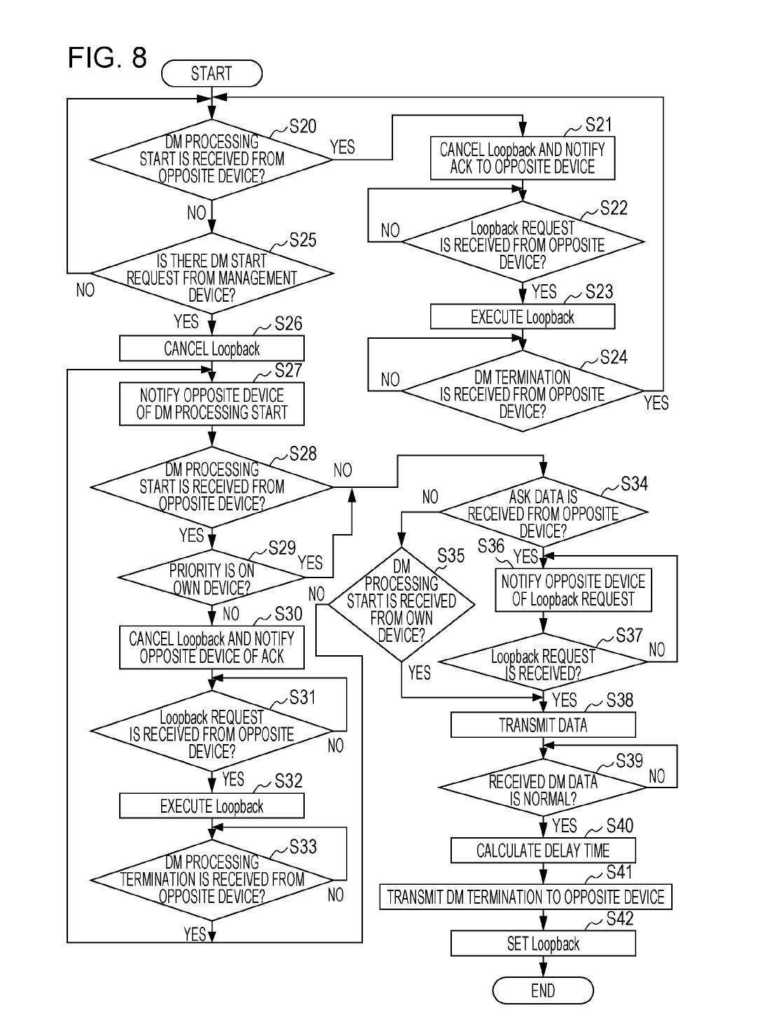

FIG. 8 is a flowchart illustrating an example of operations of the transmission devices (10 and 10A) according to the second embodiment. As illustrated in FIG. 8, once processing is started, the measurement controller 11 determines whether or not DM data to start DM processing is received from an opposite station (the opposite device 10A in the case of the transmission device 10) (S20). To be more specific, the measurement controller 11 determines whether or not the received DM data includes a DM start pattern.

When the DM data to start the DM processing is received (S20: YES), the measurement controller 11 cancels the setting of loopback of the DM bit at the selector 13, since the opposite station starts the DM. Then, the measurement controller 11 notifies the opposite station of Ack for the DM data to start the DM processing (S21). To be more specific, the measurement controller 11 transmits the DM data including an Ack pattern to the opposite device 10A that is the opposite station.

Next, the measurement controller 11 determines whether or not a loopback request is received from the opposite station (S22). To be more specific, the measurement controller 11 determines whether or not the received DM data includes a loopback request pattern. When no loopback request is received from the opposite station (S22: NO), the measurement controller 11 puts the processing on standby.

On the other hand, when the loopback request is received from the opposite station (S22: YES), the measurement controller 11 executes loopback of the DM bit at the selector 13 (S23). Thus, the opposite device 10A that is the opposite station may perform the DM.

Next, the measurement controller 11 determines whether or not DM data to terminate the DM processing is received from the opposite station (S24). To be more specific, the measurement controller 11 determines whether or not the received DM data includes a DM termination pattern. When the DM data to terminate the DM processing is not received (S24: NO), the measurement controller 11 puts the processing on standby, since the DM at the opposite station is ongoing. On the other hand, when the DM data to terminate the DM processing is received (S24: YES), the measurement controller 11 returns the processing to S20 since the DM at the opposite station is terminated.

When the DM data to start the DM processing is not received (S20: NO), the measurement controller 11 determines whether or not there is a DM start request that is a delay measurement instruction from the management device 20 (S25). When there is no DM start request (S25: NO), the measurement controller 11 returns the processing to S20 and stands by. Since no DM is performed during the standby, a DM bit value of a frame demultiplexed by the demultiplexer 16 is set as a DM bit of a transmission frame and is looped back.

When there is the DM start request (S25: YES), the measurement controller 11 cancels the setting of loopback of the DM bit at the selector 13 (S26). Next, the measurement controller 11 notifies the opposite station of the DM processing start (S27). To be more specific, the measurement controller 11 transmits DM data including a DM start pattern to the opposite device 10A that is the opposite station.

Then, the measurement controller 11 determines whether or not the DM data to start the DM processing is received from the opposite station (S28). Here, when the DM data to start the DM processing is received (S28: YES), there is a possibility that the own station and the opposite station compete against each other for the DM. Therefore, when the DM data to start the DM processing is received (S28: YES), the measurement controller 11 determines whether or not the own station has priority, based on the unit number of the received DM data (S29).

When the own station has priority (S29: YES), the measurement controller 11 advances the processing to S34 to start the DM at the own station.

On the other hand, when the own station has no priority (S29: NO), the measurement controller 11 cancels the setting of loopback of the DM bit at the selector 13, as in the case of S21. Then, the measurement controller 11 notifies the opposite station of Ack for the DM data to start the DM processing (S30).

Next, the measurement controller 11 determines whether or not a loopback request is received from the opposite station (S31). When no loopback request is received from the opposite station (S31: NO), the measurement controller 11 puts the processing on standby.

On the other hand, when the loopback request is received from the opposite station (S31: YES), the measurement controller 11 executes loopback of the DM bit at the selector 13 (S32). Thus, the opposite device 10A that is the opposite station having higher priority may perform the DM.

Next, the measurement controller 11 determines whether or not DM data to terminate the DM processing is received from the opposite station (S33). When the DM data to terminate the DM processing is not received (S33: NO), the measurement controller 11 puts the processing on standby, since the DM at the opposite station is ongoing. On the other hand, when the DM data to terminate the DM processing is received (S33: YES), the measurement controller 11 advances the processing to S34 since the DM at the opposite station is terminated.

In S34, the measurement controller 11 determines whether or not Ack data is received from the opposite station. To be more specific, the measurement controller 11 determines whether or not the received DM data includes an Ack pattern.

When the Ack data is not received from the opposite station (S34: NO), the measurement controller 11 determines, based on the unit identification information in the received DM data, whether or not DM processing start is received from the own station (S35).

When the DM processing start is not received from the own station (S35: NO), the measurement controller 11 returns the processing to S27. Thus, the transmission device 10 continues to notify the DM processing start until the Ack data is received from the opposite station.

On the other hand, when the DM processing start is received from the own station (S35: YES), the opposite device 10A that is the opposite station does not support the operation to start the DM by executing Ack for the DM processing start. Therefore, the measurement controller 11 advances the processing to S38 to start the DM.

When the Ack data is received from the opposite station (S34: YES), the measurement controller 11 notifies the opposite station of a loopback request (S36). To be more specific, the measurement controller 11 transmits DM data including a loopback request pattern to the opposite device 10A that is the opposite station.

Next, the measurement controller 11 determines, based on the unit identification information in the received DM data, whether or not the loopback request is received from the own station (S37). When the loopback request is not received from the own station (S37: NO), the measurement controller 11 returns the processing to S36 to continue to notify the opposite station of the loopback request.

When the loopback request is received from the own station (S37: YES), the measurement controller 11 advances the processing to S38 to start the DM, since the loopback request from the own station is returned to the own station through the opposite station.

In S38, the measurement controller 11 starts transmitting DM data for the DM (S38). Then, the measurement controller 11 determines whether or not the DM data received by the own station is normal (S39). When the DM data received by the own station is not normal (S39: NO), the measurement controller 11 puts the processing on standby since the DM data transmitted in S38 is not back yet.

On the other hand, when the DM data received by the own station is normal (S39: YES), the measurement controller 11 calculates an actual delay time based on the delay time measured by the delay time measurement unit 18 (S40).

Next, the measurement controller 11 transmits DM termination to the opposite station (S41). To be more specific, the measurement controller 11 transmits DM data including a DM termination pattern. Then, the measurement controller 11 sets loopback at the selector 13 (S42).

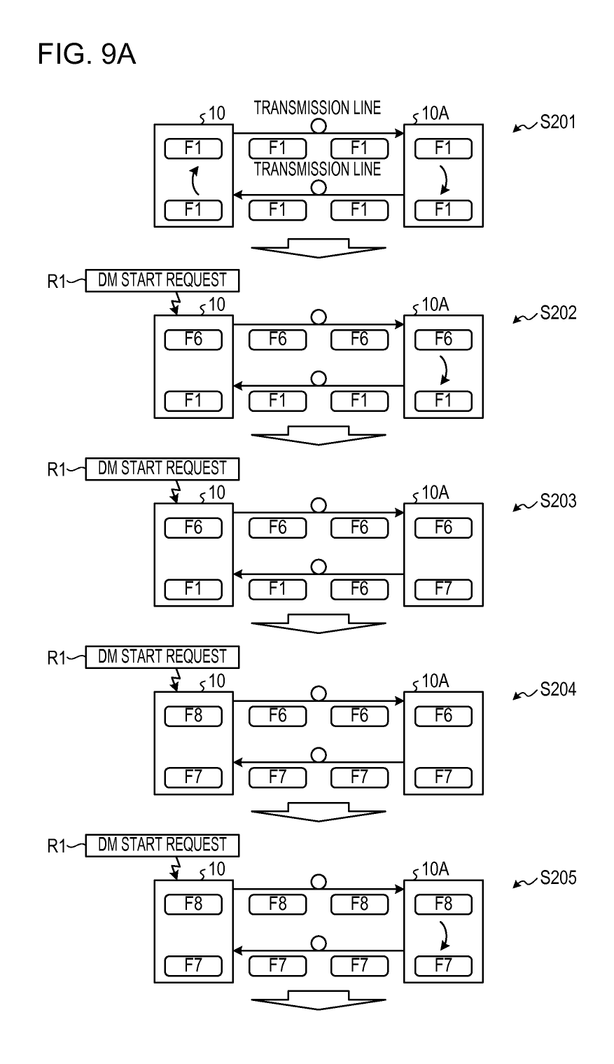

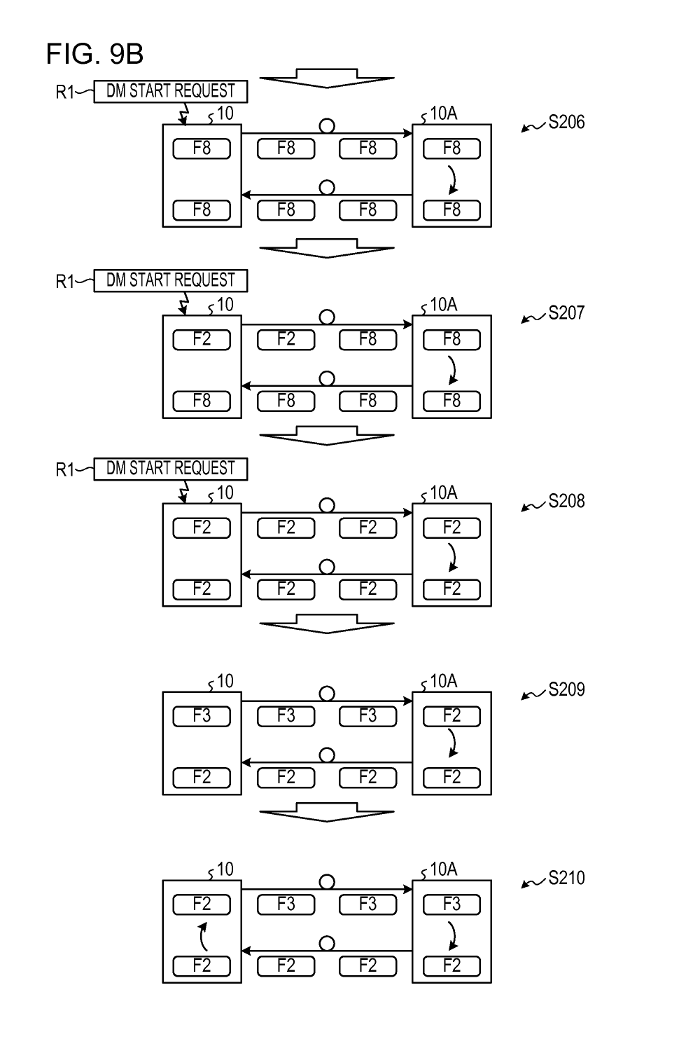

Here, description is given of each case of an operation example of the transmission device 10 according to the second embodiment. First, description is given of a case where DM is performed at the transmission device 10 and no DM is performed at the opposite device 10A. FIGS. 9A and 9B are explanatory diagrams illustrating an operation example of the transmission devices (10 and 10A) according to the second embodiment.

As illustrated in FIGS. 9A and 9B, before the transmission device 10 receives a DM start request R1 (S201), DM bits of frames F1 transmitted and received between the transmission device 10 and the opposite device 10A are in a loopback state. Also, each of the frames F1 has an indefinite DM bit value since no DM data settings are configured.

Next, upon receipt of the DM start request R1 from the management device 20, the transmission device 10 sequentially transmits frames F6 having the DM data according to the DM start request R1 to the transmission line 101 (S202). Here, the DM data transmitted through the frames F6 includes control information, unit identification information, order number, and CRC, and the control information is a DM start pattern. Also, the transmission device 10 cancels the setting of loopback of the DM bit.

Thereafter, upon receipt of the frames F6 having the DM data according to the DM start pattern, the opposite device 10A recognizes that the transmission device 10 has started the DM. Then, the opposite device 10A cancels the setting of the loopback and sequentially transmits frames F7 having the DM data according to Ack pattern to the transmission line 101 (S203). Here, the DM data transmitted through the frames F7 includes control information, unit identification information, order number, and CRC, and the control information is an Ack pattern.

Next, upon receipt of the frames F7 having the DM data according to the Ack pattern, the transmission device 10 sequentially transmits frames F8 to the transmission line 101 (S204). Here, the DM data transmitted through the frames F8 includes control information, unit identification information, order number, and CRC, and the control information is a loopback request pattern.

Then, upon receipt of the frames F8 having the DM data according to the loopback request pattern, the opposite device 10A sets loopback of the DM bit at the selector 13 (S205).

Thereafter, when the DM data is the one transmitted from the own station and upon receipt of the DM data according to the loopback request pattern (S206), the transmission device 10 executes the DM as in the case of S102 to S105 (S207 to S210).

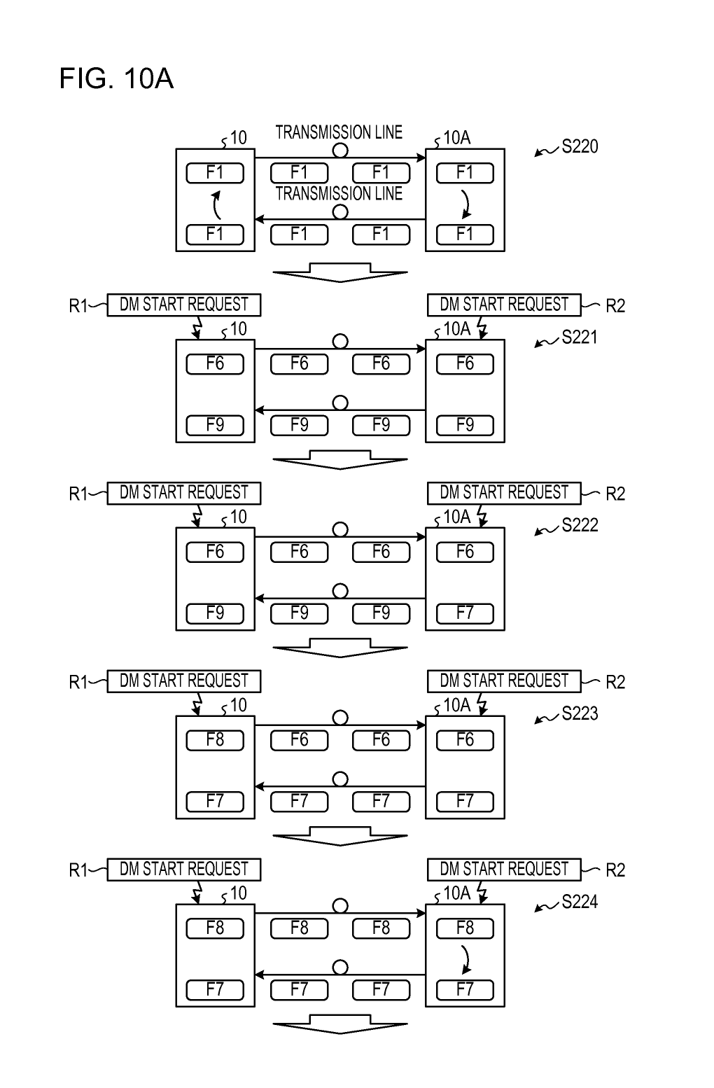

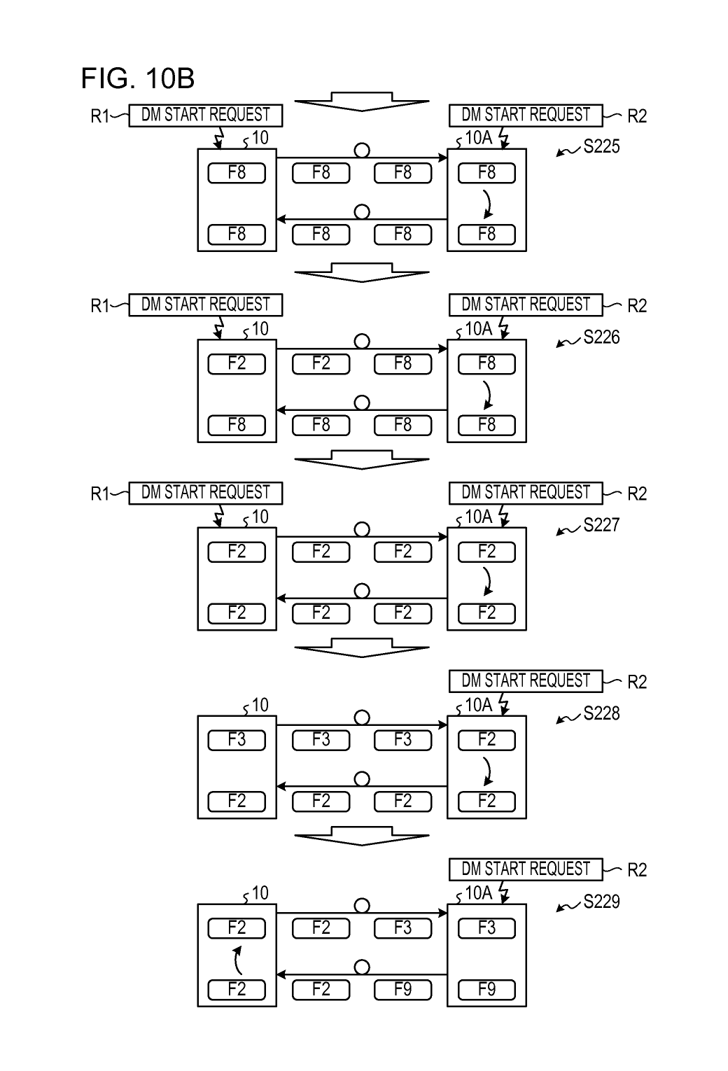

Next, description is given of a case where the transmission device 10 and the opposite device 10A receive DM start requests R2 approximately at the same time. FIGS. 10A and 10B are explanatory diagrams illustrating an operation example of the transmission devices (10 and 10A) according to the second embodiment.

As illustrated in FIGS. 10A and 10B, before the transmission device 10 and the opposite device 10A receive the DM start requests R1 and R2 (S220), DM bits of frames F1 transmitted and received between the transmission device 10 and the opposite device 10A are in a loopback state. Also, each of the frames F1 has an indefinite DM bit value since no DM data settings are configured. Moreover, the transmission device 10 is set to have higher priority.

Then, the transmission device 10 and the opposite device 10A receive the DM start requests R1 and R2 approximately at the same time, and the both stations start the DM (S221). In this event, the transmission device 10 sequentially transmits frames F6 having the DM data according to the DM start request R1 to the transmission line 101. Also, the opposite device 10A sequentially transmits frames F9 having the DM data according to the DM start request R2 to the transmission line 101. As to the DM data transmitted through the frames F9, as in the case of the frames F6, the control information is a DM start pattern. Moreover, the transmission device 10 and the opposite device 10A cancel settings of loopback of the DM bit.

After the start of the DM, the transmission device 10 receives the frames F9 having the DM start pattern of the opposite device 10A, while the opposite device 10A receives the frames F6 having the DM start pattern of the transmission device 10 (S222). Here, both of the transmission device 10 and the opposite device 10A determine the priority based on the unit number of the received DM data.

In this case, since the transmission device 10 is set to have higher priority, the DM on the transmission device 10 side is continued. Then, on the opposite device 10A side, the DM is suspended, the frames F7 having the Ack pattern are transmitted to the transmission device 10, and loopback of the DM bit is set. Thereafter, as in the case of S204 to S209, the DM on the transmission device 10 side is performed (S223 to S228).

Next, upon confirmation of the receipt of DM termination from the transmission device 10, the opposite device 10A sequentially transmits the frames F9 to start the DM (S229).

As described above, even when the transmission device 10 and the opposite device 10A receive the DM start requests R1 and R2 at the same time, the DM may be performed in descending order of priority based on the unit identification information in the DM data from the transmission device 10, by cooperatively starting the DM.

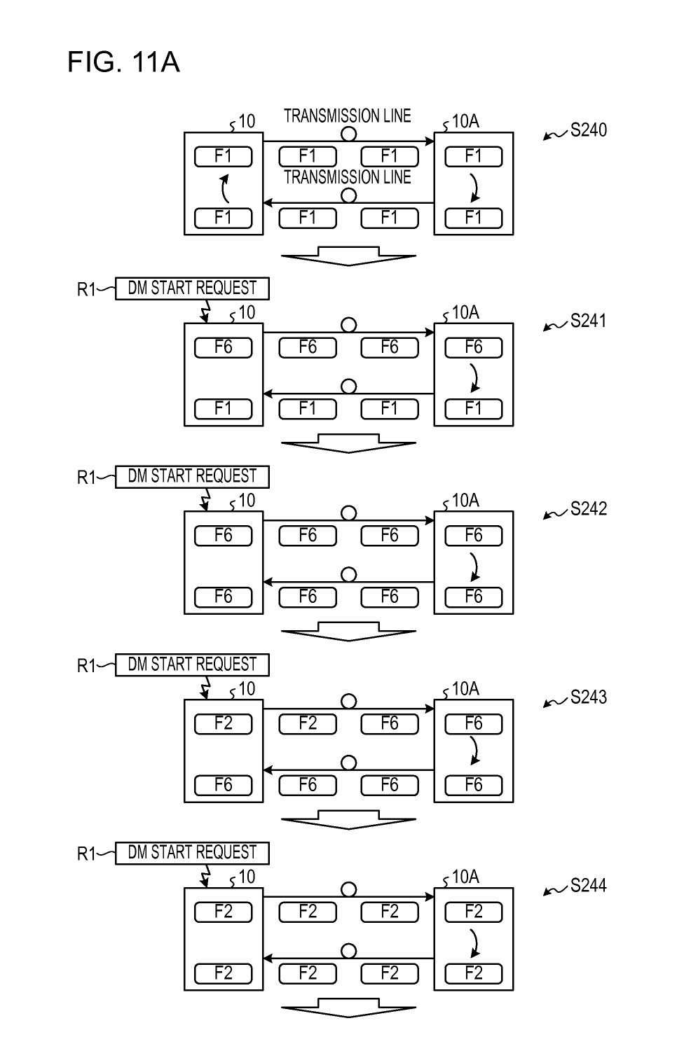

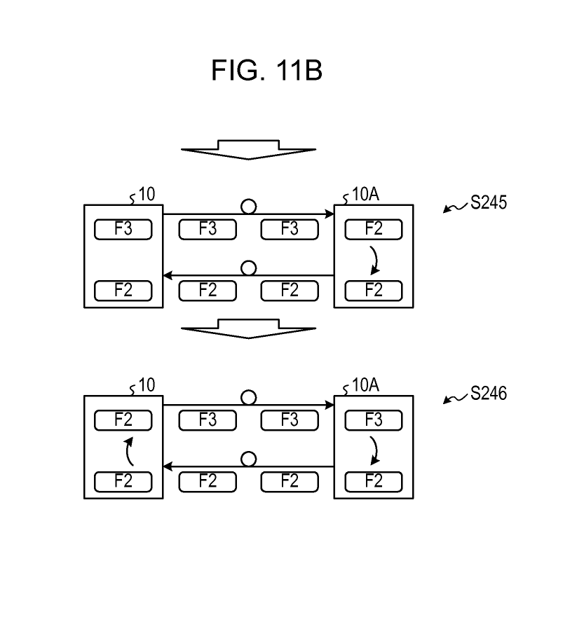

Next, description is given of a case where the opposite device 10A side does not support the operations described above. FIGS. 11A and 11B are explanatory diagrams illustrating an operation example of the transmission devices (10 and 10A) according to the second embodiment.

As illustrated in FIGS. 11A and 11B, before the transmission device 10 receives a DM start request R1 (S240), DM bits of frames F1 transmitted and received between the transmission device 10 and the opposite device 10A are in a loopback state. Also, each of the frames F1 has an indefinite DM bit value since no DM data settings are configured. Moreover, the opposite device 10A does not support the operations illustrated in FIG. 8, but is configured to perform operations corresponding to ITU-T G.709 standards.

Then, upon receipt of the DM start request R1 from the management device 20, the transmission device 10 sequentially transmits frames F6 having the DM start pattern to the transmission line 101 (S241). Moreover, the transmission device 10 cancels the setting of loopback of the DM bit.

The opposite device 10A does not support the operations illustrated in FIG. 8, and thus loops back the frames F6 without making any change thereto (S242). Then, the transmission device 10 receives the frames F6, which are transmitted from the own station (S242).

Upon receipt of the frames F6 having the DM start pattern transmitted by the own station, the transmission device 10 determines that the opposite device 10A does not support the operations illustrated in FIG. 8. Thus, the transmission device 10 executes the DM as in the case of S102 to S105 (S243 to S246). Therefore, even when the opposite device 10A does not support the operations described above, the transmission device 10 may perform the DM.

As described above, the transmission device (10 or 10A) that transmits and receives frames to and from the opposite device transmits, when measuring a transmission delay between the transmission device and the opposite device, frames having predetermined bits attached thereto to the opposite device such that a bit string of the predetermined bits has a predetermined pattern. Then, the transmission device (10 or 10A) determines a delay time in transmission delay by measuring time between the transmission of the bit string having the predetermined pattern to the opposite device and the reception of the bit string having the predetermined pattern from the opposite device. Thus, false detection may be suppressed in measurement of a transmission delay between nodes, the opposite device, and the transmission device.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
a transmitter configured to transmit frames including a bit string having a predetermined pattern to an opposite device to the transmission device;
a measurement unit configured to measure an elapsed time from a first time at the transmission of the frames including the bit string having the predetermined pattern to the opposite device to a second time at a reception of the frames including the bit string having the predetermined pattern from the opposite device; and
a determination unit configured to determine a transmission delay time between the transmission device and the opposite device, based on the measurement result of the measurement unit.

2. The transmission device according to claim 1,
wherein the transmitter transmits frames in which error check information for the bit string having the predetermined pattern is included, and
wherein the second time is a time when the frames including the bit string having the predetermined pattern which is determined to be valid based on the error check information are received.

3. The transmission device according to claim 1,
wherein the transmitter transmits, to the opposite device, frames in which control information to indicate a control state of the transmission device is included with the bit string having the predetermined pattern, and
the transmission device further comprising:
a controller configured to control measurement of the transmission delay based on control information included in frames received from the opposite device.

4. The transmission device according to claim 3,
wherein the transmitter transmits, to the opposite device, frames in which the control information includes information concerned with transmission delay measurement of the transmission device, and
wherein the controller controls the transmission delay measurement of the transmission device, based on information concerned with transmission delay measurement of the opposite device, the information being included in the control information of frames received from the opposite device.

5. The transmission device according to claim 3,
wherein the transmitter transmits, to the opposite device, frames in which identification information to identify the transmission device is included with the bit string having the predetermined pattern, and
wherein the controller controls the transmission delay measurement based on priority between the transmission device and a device identified by the identification information included in frames received from the opposite device.

6. A delay measurement method for a transmission device to measure a transmission delay between the transmission device and an opposite device to the transmission device, the transmission device configured to transmit and receive frames to and from the opposite device, the delay measurement method comprising:
transmitting frames including a bit string having a predetermined pattern to the opposite device;
measuring an elapsed time from a first time at the transmission of the frames including the bit string having the predetermined pattern to the opposite device to a second time at a reception of the frames including the bit string having the predetermined pattern from the opposite device; and
determining a transmission delay time between the transmission device and the opposite device, based on the measurement result of the measuring.
